(19) United States
(12) Patent Application Publication
(10) Pub. No.: US 2006/0171426 A1
(43) Pub. Date: Aug. 3, 2006

(54) Fiber-laser with intracavity polarization maintaining coupler providing plane polarized output

(76) Inventors: Andrei Starodoumov, Cupertino, CA (US); Skip Bettencourt, Santa Clara, CA (US); Paul Crittenden, Woodside, CA (US)

Correspondence Address: STALLMAN & POLLOCK LLP, 353 SACRAMENTO STREET, SUITE 2200, SAN FRANCISCO, CA, 94111, US

(21) Appl. No.: 11/049,412

(22) Filed: Feb. 2, 2005

(51) Int. Cl. H01S 3/30

(52) U.S. Cl. 372/6

(57) ABSTRACT

A fiber-laser comprises a laser cavity including a gain-fiber. A polarization maintaining fiber coupler (PM-coupler) located in the laser cavity and configured such that the fiber-laser delivers plane-polarized output radiation. The laser cavity may be configured as a linear cavity or as a ring cavity and operated in either cavity configuration in CW or pulsed modes. The PM-coupler, while providing the function of a intra-cavity polarizing element, can additionally function as a wavelength division multiplexing (WDM) coupler. Preferred embodiments of the laser include an intracavity polarization maintaining WDM element functioning jointly as an intra-cavity polarizing element and an element for coupling pump light into the cavity.

### TECHNICAL FIELD OF THE INVENTION

The present invention relates in general to optical fiber lasers (hereinafter simply fiber-lasers). The invention relates in particular to fiber-lasers having polarized output.

### DISCUSSION OF BACKGROUND ART

A fiber-laser can be regarded as an efficient converter of low-brightness multimode radiation from a diode-laser or a plurality of such lasers to high-brightness single-mode radiation. The low-brightness radiation is used to optically pump the fiber laser, which delivers the high-brightness single-mode radiation as a result of the optical pumping. Fiber-lasers are increasingly used in applications that require compact and robust monolithic laser design, good stability and excellent beam quality. The excellent beam quality results, inter alia, from the single-mode characteristic and a uniform symmetrical beam cross section of radiation that can be delivered. In many of the applications, the laser radiation is required to be plane polarized. Such applications include interferometric sensors, optical pumping of parametric amplifiers and oscillators, harmonic generation, and fabrication of mode-locked, Q-switched or single-frequency fiber-lasers.

In an “ideal” optical fiber having a perfectly round refractive-index profile, a signal injected into one end of the optical fiber will propagate through the optical fiber with its polarization state unchanged, whatever that state may be. Each of the transverse modes supported by the ideal optical fiber can exist in two orthogonal polarization states, for example, vertical and horizontal. In the perfectly symmetric, ideal, optical fiber, these two polarization modes propagate at the same speed, independent of one another, i.e., the fiber is not birefringent. In practice, however, an optical fiber has an imperfect azimuthal symmetry, and, thus exhibits non-zero birefringence.

The imperfect azimuthal symmetry in a practical optical fiber may result from factors including core or cladding ellipticity, mechanical strain “frozen” in the optical fiber during a drawing process, or mechanical strain induced by bending or twisting the optical fiber. Any one of these factors can cause random refractive-index perturbations, generally termed “random birefringence”, resulting in a non-polarization-maintaining behavior of the optical fiber.

Effects of random birefringence may be overcome by utilizing a polarization-maintaining optical fiber (hereinafter PM-fiber) in which birefringence has been deliberately induced in an orderly manner. In such a PM-fiber the polarization planes of linearly polarized light waves launched into the optical fiber are maintained during propagation, with little or no cross coupling of optical power between the orthogonal polarization modes. Each polarization mode propagates at its own speed, and the speed difference of two polarization states depends on the birefringence of the optical fiber. Typical fiber birefringence is in a range of nₓ−n_{y} between about 1×10⁻⁴ and 8×10⁻⁴, where nₓ, n_{y} are effective refractive indices for light polarized in orthogonal, transverse, X- and Y-axes. These axes are often referred to as the, “slow-” and “fast-” axes. Light polarized along the “slow-axis” propagates slower than light polarized along the “fast-axis”.

A PM-fiber having a symmetrical, i.e., round core is usually preferred. A round core is preferred because other fiber-laser elements, such as fiber Bragg gratings (FBGs), modulators, and filters are typically made using round-core fibers. This facilitates manufacture of optical assemblies for coupling light in and out of the fiber-laser elements. Birefringence in a PM-fiber is introduced by the shape or construction of the PM-fiber cladding.

FIG. 1 is a cross-section view schematically illustrating one generally used example 10 of a PM-fiber, commonly referred to as a “Panda” PM-fiber. Traditional cross-hatching is used sparingly in this, and in similar drawings referred to hereinafter, for clarity of illustration. Panda PM-fiber 10 has a round core 12 surrounded by a cladding 14, typically of fused silica. Two rods 16 located in the cladding of the fiber, and made from a material other than fused silica (typically, boron doped silica), provide a stress pattern that forces radiation with polarization oriented along the X- or slow-axis (indicated in FIG. 1 by a dashed line) to propagate slower than radiation with orthogonal polarization, which, of course, will be is oriented in the Y- or fast-axis (also indicated by a dashed line). The slow axis is in the same plane as the rods, which can be described generally as stress applying parts (SAPs).

FIG. 2 is a cross-section view schematically illustrating another generally-used example 18 of round-core PM-fiber 18. PM-fiber 18 is similar to PM-fiber 10 with an exception that SAPs 20 of PM fiber 18 have a trapezoidal cross section. This example of a PM-fiber is commonly referred to as a “bow-tie” PM-fiber because of the shape and arrangement of the SAPs. Again, the slow-axis is in the plane of the SAPs and the fast-axis is oriented orthogonally to the fast axis.

FIG. 3 is a cross-section view schematically illustrating yet another generally-used example 24 of a round-core PM- fiber. The PM-fiber has a round core 12 surrounded by a first cladding 14E, here, having an elliptical cross section. Cladding 14E forms an asymmetrical stress pattern in the core. Cladding 14E is surrounded by a second cladding 22 having a round cross-section. This type of PM-fiber is suitable as a gain-fiber (with core 12 being doped) wherein pump light is injected into the inner cladding of the fiber.

FIG. 4 is a cross-section view schematically illustrating a generally-used example 26 of a PM-fiber having an elliptical core 12E surrounded by a cladding 14. Polarization properties of PM-fiber 26 are imparted by the elliptical core. Here, light travels faster in the minor axis of the elliptical core than in the major axis thereof.

In all of the above-described and other types of PM fiber, two orthogonal polarization modes have different propagation constants and speeds. With all PM fibers and components, it is necessary to launch light (radiation) into either the slow or the fast axis to maintain polarization. Those skilled in the art to which the present invention pertains will recognize without further description or illustration that any of the above-described PM-fibers could be fabricated as double-clad fibers by providing an additional (outer) cladding surrounding the fibers. Such double cladding has advantages for optically pumping a gain fiber by directing pump light into the inner cladding of the double-clad fiber. Gain-fibers and arrangements for pumping double-clad fibers are discussed further hereinbelow. While above described PM-fibers are describe in terms of such fibers having orthogonally oriented polarization axes, it is possible to fabricate PM-fibers in which the polarization axes are non orthogonally oriented.

A fiber-laser made from nominally isotropic optical fibers having above-described random birefringence provides depolarized output radiation because different lasing modes have different polarization, generally elliptical. Superposition of these modes results in the depolarized output radiation. Further, the random birefringence in the nominally isotropic fibers may result in changes of mode polarization with time due to temperature variations.

A laser made with PM-fibers provides laser radiation in two polarization states. Polarization controllers can help to convert this radiation into a linear polarization, but temperature variations and a broad radiation frequency spectrum make it hard to control this polarization. Changes in the birefringence properties of the optical fiber over time necessitate readjustment of the polarization controller, a problem which makes such a fiber-laser unsuitable for many practical applications.

One prior-art solution to this problem is to locate a polarizer in the PM-fiber-laser cavity. The polarizer works as a polarization mode selector, providing stable operation of the laser with linearly polarized output radiation.

One type of polarizer that is used for this purpose is a bulk polarizer including a micro-optics assembly to couple light in and out of the fiber laser components. This type of a polarizer, however, exhibits high insertion loss, for example greater than 0.5 decibels (dB), for the preferred polarization. Further, use of this bulk polarizer is usually limited to low power applications, for example, applications where average power less than about 500 milliwatts (mW) is required. This is because of a low threshold for optical (laser radiation) damage in the micro-optics assembly.

Another type of polarizer that is used to solve the problem of providing stable polarized output radiation from a PM-fiber-laser is an all-fiber polarizer. Such a polarizer includes an optical fiber having a non-round core geometry and arrangements to apply stress to the core. In such a fiber-polarizer, one polarization mode leaks out of the core, while the other propagates with much less loss. This type of polarizer, however, exhibits even higher insertion loss, for example, greater than about 1.5 dB in a laser cavity than the above-discussed bulk polarizer. The source of this insertion loss results from losses at spliced junctions of the non-round core of the fiber-polarizer with the round core of other fiber components of the laser.

Another prior art solution to the problem of providing linearly polarized output from a fiber-laser uses a gain-fiber coiled under tension around a spool. This results in stress-induced birefringence in the gain-fiber. For optical fibers with low numerical aperture (NA) less than about 0.1, such a coiling causes extra loss for one polarization compared to the other one. As a result, linearly-polarized output may be achieved in a laser using such a tension-coiled gain-fiber. A disadvantage of this method is that it is optimally effective only for large mode-area, low-NA optical fibers. Such optical fibers are usually used for fiber-amplifiers and not for fiber-lasers or master oscillators (MOs). A further disadvantage is that spooling of such fiber is not a repeatable process, and strongly depends on fiber quality.

There is a need for a simple and reliable method for polarization selection in a fiber-laser cavity. The method should minimize intra-cavity loss due to the polarization selection and be applicable to fiber-lasers operating in continuous wave (CW) and pulsed modes, including mode-locked modes.

### SUMMARY OF THE INVENTION

The present invention is directed to providing a fiber-laser with plane polarized output. In one aspect a fiber-laser in accordance with the present invention comprises a laser cavity including a gain-fiber. A polarization maintaining fiber coupler (PM-coupler) located in the laser cavity and configured such that the fiber-laser delivers plane-polarized output radiation.

In certain embodiments output radiation can have an extinction ratio greater than about 13 dB with the PM-coupler causing insertion loss for the preferred polarization orientation of less than about 5%. In other embodiments of the inventive laser the output radiation can have an extinction ratio greater than about 13 dB with the PM-coupler causing insertion loss for the preferred polarization orientation of less than about 10%.

In another aspect of the invention, the laser cavity may be configured as a linear (standing-wave) cavity or as a ring cavity. The inventive laser may be operated in either cavity configuration in continuous wave (CW) or pulsed including mode-locked modes. The PM-coupler, while providing the function of an intra-cavity polarizing element, can additionally provide one or more of the functions of an output coupling element, a (polarization maintaining) wavelength division multiplexing (WDM) element for coupling pump light into the laser cavity, and a WDM element for attenuating amplified spontaneous emission (ASE) by preferentially coupling such ASE out of the laser cavity. Other aspects and embodiments of the invention will be evident to one skilled in the art from the detailed description presented hereinbelow.

### BRIEF DESCRIPTION OF THE DRAWINGS

The accompanying drawings, which are incorporated in and constitute a part of the specification, schematically illustrate a preferred embodiment of the present invention, and together with the general description given above and the detailed description of the preferred embodiment given below, serve to explain the principles of the present invention.

FIG. 1 is a cross-section view schematically illustrating one example of a PM-fiber having a round core surrounded by a round cladding including two embedded round rods providing a differential stress in the core.

FIG. 2 is a cross-section view schematically illustrating another example of a PM-fiber similar to the PM-fiber of FIG. 1 but wherein the stress-providing rods have a trapezoidal cross-section.

FIG. 3 is a cross-section view schematically illustrating yet another example of a PM-fiber having a round core surrounded by an elliptical first cladding, the first cladding being immersed in a round second cladding.

FIG. 4 is a cross-section view schematically illustrating still another example of a PM-fiber having an elliptical core immersed in a round cladding.

FIG. 5 schematically illustrates four-port polarization-maintaining coupler (PM-coupler) constructed from two lengths of PM-fiber tapered and fused together over a predetermined length with a predetermined separation between the cores thereof.

FIG. 5A is a cross-section view seen generally in a direction 5A-A of FIG. 5 illustrating one cross-section of the fused-together length of the polarization maintaining coupler of FIG. 5 wherein the PM-fibers are fibers having the configuration of the PM-fiber of FIG. 1.

FIG. 5B is a cross-section view seen generally in a direction 5A-A of FIG. 5 illustrating another cross-section of the fused-together length of the polarization maintaining coupler of FIG. 5 wherein the PM-fibers are fibers having the configuration of the PM-fiber of FIG. 2.

FIG. 5C is a cross-section view seen generally in a direction 5A-A of FIG. 5 illustrating yet another cross-section of the fused-together length of the polarization maintaining coupler of FIG. 5 wherein the PM-fibers are fibers having the configuration of the PM-fiber of FIG. 3.

FIG. 5D is a cross-section view seen generally in a direction 5A-A of FIG. 5 illustrating still another cross-section of the fused-together length of the polarization maintaining coupler of FIG. 5 wherein the PM-fibers are fibers having the configuration of the PM-fiber of FIG. 4.

FIG. 6 schematically illustrates a one preferred embodiment of a CW fiber-laser in accordance with the present invention having a standing-wave fiber-laser cavity terminated by first and second fiber-Bragg gratings and including a polarization-maintaining coupler arranged to deliver output radiation from the laser cavity.

FIG. 7 schematically illustrates another preferred embodiment of a CW fiber-laser in accordance with the present invention similar to the fiber-laser of FIG. 1 but wherein the standing-wave fiber-laser cavity is terminated by a fiber-Bragg grating and a fiber Sagnac interferometer including the PM-coupler.

FIG. 8 schematically illustrates one preferred embodiment of a pulsed fiber-laser in accordance with the present invention having a standing-wave fiber-laser cavity terminated by a fiber-Bragg gratings and a dielectric mirror, and including a modulating device for causing pulsed mode operation of the laser and a PM-coupler arranged to deliver output radiation from the laser cavity.

FIG. 9 schematically illustrates one preferred embodiment of a CW fiber-laser in accordance with the present invention having a traveling-wave fiber-laser cavity formed by a fiber loop and including a PM-coupler configured as a polarization maintaining wavelength division multiplexer (PM-WDM) arranged to deliver optical pump-radiation into the laser cavity and deliver output radiation from the laser cavity.

FIG. 10 schematically illustrates one preferred embodiment of a pulsed fiber-laser in accordance with the present invention having a traveling-wave fiber-laser cavity formed by a fiber loop and including a modulator for causing pulsed operation of the laser, and a PM-WDM arranged to deliver optical pump-radiation into the laser cavity and deliver output radiation from the laser cavity.

FIG. 11 schematically illustrates one preferred embodiment of a mode-locked, standing-wave-cavity, pulsed fiber-laser in accordance with the present invention similar to the laser of FIG. 8 but wherein a separate modulator is omitted and the laser cavity is terminated by the fiber Bragg grating and by a semiconductor saturable absorber mirror (SESAM) for providing mode-locked operation, the SESAM being spaced apart from optical fibers of the fiber-laser cavity.

FIG. 12 is a graph schematically illustrating reflected intensity as a function of wavelength for the fiber Bragg grating in forward and reverse orientations in an experimental example of the laser of FIG. 11.

FIG. 13 is a graph schematically illustrating transmitted intensity as a function of wavelength for the fiber Bragg grating of FIG. 12 in a reverse orientation.

FIG. 14 is a graph schematically illustrating reflection as a function of wavelength for the SESAM in the experimental example of the laser of FIG. 11.

FIG. 15 is a graph schematically illustrating intensity as a function of wavelength for pulses of two different power levels delivered by the experimental example of the laser of FIG. 11 with the fiber Bragg grating in reverse orientation.

FIG. 16 is a graph schematically illustrating intensity as a function of wavelength for pulses of two different power levels delivered by the experimental example of the laser of FIG. 11 with the fiber Bragg grating in forward orientation.

FIG. 17 schematically illustrates another preferred embodiment of a mode-locked, standing-wave-cavity, pulsed fiber-laser in accordance with the present invention similar to the laser of FIG. 11, but wherein the SESAM is butt coupled to an optical fiber of the fiber-laser cavity.

FIG. 18 schematically illustrates yet another preferred embodiment of a mode-locked, standing-wave-cavity, pulsed fiber-laser in accordance with the present invention similar to the laser of FIG. 11, but wherein a PM-coupler is located in the fiber laser cavity and configured as a PM-WDM for coupling pump light into the laser cavity.

FIG. 19 schematically illustrates still another preferred embodiment of a mode-locked, standing-wave-cavity, pulsed fiber-laser in accordance with the present invention similar to the laser of FIG. 11, but wherein a the laser cavity is terminated by a highly reflecting dielectric mirror and a semiconductor saturable absorber mirror (SESAM) for providing mode-locked operation, and wherein a PM-coupler is located in the fiber laser cavity and configured as a PM-WDM for coupling pump light into the laser cavity, with a diffraction grating pair also located in the laser cavity for providing negative group dispersion delay.

### DETAILED DESCRIPTION OF THE INVENTION

As summarized above, a fiber-laser in accordance with the present invention provides polarized output by including a polarization maintaining coupler (PM-coupler) in a fiber-laser cavity. Preferably, the gain fiber of the cavity and other optical fibers in the cavity are PM-fibers.

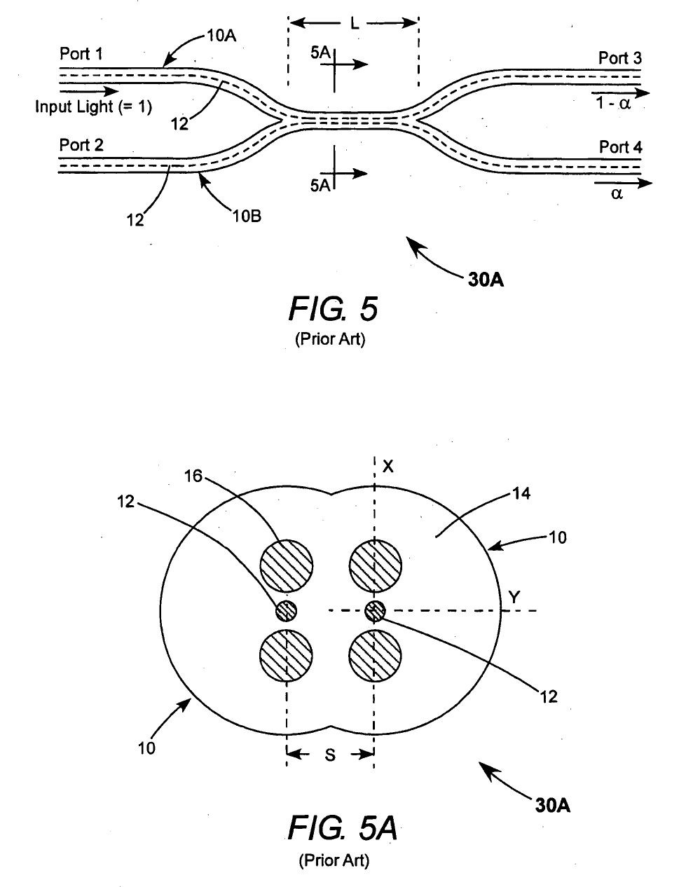

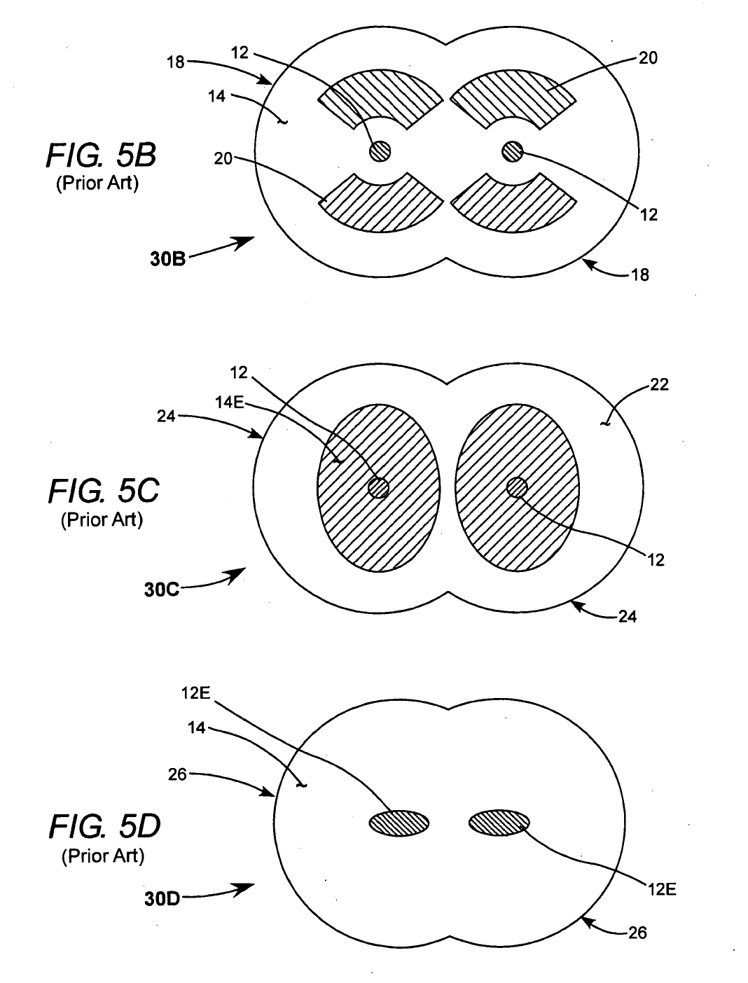

Referring now to the drawings, wherein like components are designated by like reference numerals, FIG. 5 and FIG. 5A schematically illustrate one example 30A of a PM-coupler in which light is coupled between two above-described Panda PM-fibers 10 designated as PM-fibers 10A and 10B in FIG. 5 to facilitate description. The fibers are partially tapered with claddings thereof fused together over a length L, and with cores 12 thereof (indicated in phantom in FIG. 5) spaced apart by a distance S. PM-coupler 30A can be defined as having four ports, indicated as ports 1-4 in FIG. 5. Ports 1 and 3 are at opposite ends of PM-fiber 10A. Ports 2 and 4 at opposite ends of PM-fiber 10B. The coupler is arranged here in generic form with unit input launched into port 1 (of PM-fiber 10A) of the coupler. A fraction a of the input is coupled into the core of fiber 10B and exits the coupler via port 4 thereof, while a fraction 1—α of the input exits port 3 of the coupler. A PM-coupler is preferably made with single-mode PM-fibers.

Those skilled in the art will recognize that were unit input launched into port 3 of the coupler, fractions 1-α and α would exit at ports 1 and 2 of the coupler respectively. Those skilled in the art will also recognize that fraction α of FIG. 5 depends, among other factors on length L in which cores 12 of fibers 10A and 10B are brought into proximity, the separation S of the cores over this length and the wavelength of the input radiation.

A PM-coupler such as coupler 30A of FIG. 5 has different coupling ratios and other differential losses for the two polarization states. This difference may not be enough to provide an adequate polarization extinction ratio in one pass, through the coupler. When the coupler included, in accordance with the present invention, in a fiber-laser cavity, radiation will circulate (oscillate) either progressively or reciprocally (depending on the cavity arrangement) several times through the coupler. Because of this, the PM-coupler essentially eliminates oscillations in a polarization state with highest losses, resulting in highly polarized output from the laser cavity. The extinction ratio of output from a low Q factor, for example, having a Q factor of about 5×10⁶, may be about 13 decibels (dB) or greater. The extinction ratio of output from a cavity having, for example, a Q factor greater than 3×10⁶ may be about 20 dB or greater.

As used herein and in the claims, the term “coupler losses” for the two polarization states is intended to cover both the differential losses created by the selected coupling ratio (α:α-1) as well as the actual losses, caused for example, by differences in insertion losses or other losses (e.g. scattering) in the fiber coupler.

It should be noted that what is generically described in this description and the appended claims as a PM-coupler may be configured to fulfill functions including but not limited to those of a polarization-maintaining wavelength-division multiplexer (PM-WDM), a polarization maintaining tap (PM-tap) with coupling ratio (α) less than about 1%, a PM-coupler with splitting ratio (α) between about 1% to 50%, or a PM-polarization combiner. The particular configuration will depend among others on length L spacing S, among other factors as is known in the art.

Polarization combiner combines light at two orthogonal polarization states from two fibers in one fiber or splits light at two orthogonal polarization states propagating in one fiber into two separate fibers. Such a polarization combiner provides the highest discrimination between two polarization states in a laser cavity typically above 10 dB. At any practical value of the Q-factor of a fiber laser cavity (Q>10⁵) such a polarization combiner will provide a high polarization extinction ratio (>16 dB) at a laser output.

A PM-coupler, a PM-tap, or a PM-WDM can be designed to have an equal coupling ratio for both polarization states. In such a case, only a difference in an insertion loss coefficient helps to discriminate polarization state. Insertion loss difference can be a few percent, for example, between 1% and 5%. In this case, a cavity with a higher Q-factor, for example, greater than 5×10⁶, (i.e., many round-trips for photon before the photon leaves the cavity) is required to select one polarization state for lasing.

It should be noted that at the threshold of laser generation, only light at the polarization state with lower loss is generated. However, a fiber-laser exhibits very strong gain per one round-trip in the cavity (typically more than 10 dB). At some pump power level a threshold of generation can be also achieved for light at the second polarization state. As a result, polarization extinction ratio will degrade. To expand a power range with a good polarization extinction ratio (>10 dB) PM couplers with a larger differentiation in coupling ratio (>5%) or insertion loss (>5%) for two polarization states are required.

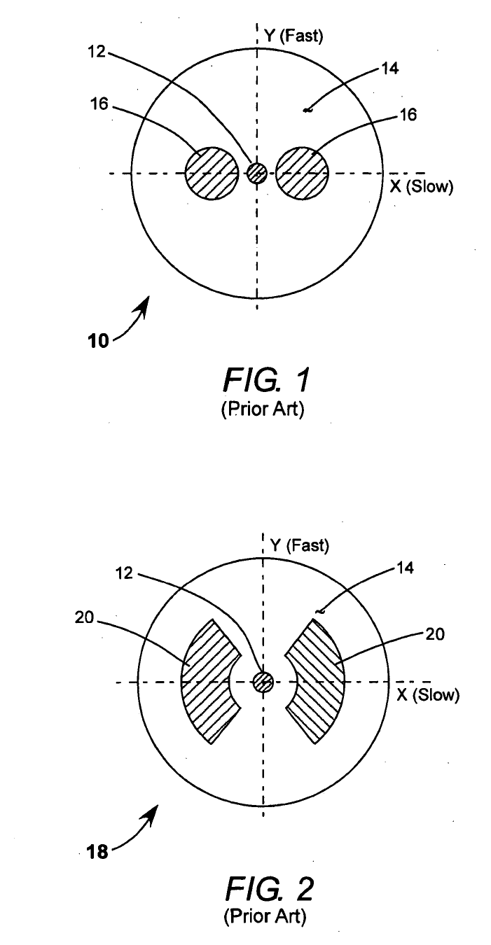

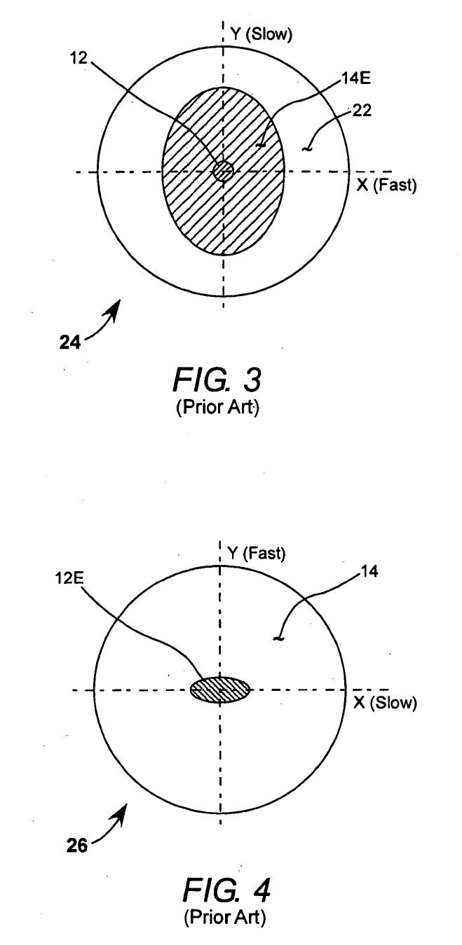

While coupler 30A is described above as being constructed from Panda type PM-fibers 10 of FIG. 1, such couplers can also be constructed from other types of fiber. By way of example: FIG. 5B schematically illustrates (in cross-section only) a PM-coupler 30B constructed from bow-tie type PM-fibers 18 of FIG. 2; FIG. 5C schematically illustrates a coupler 30C constructed from tiger type PM-fibers 24 of FIG. 3; and FIG. 5D schematically illustrates a PM-coupler 30D constructed from elliptical-core PM-fibers 26 of FIG. 4.

Embodiments of the inventive fiber-lasers having a laser cavity including a PM-coupler in certain of the above-described configurations are described hereinbelow. In each of the examples, the PM-coupler is designated by a general numeral 30 independent of the type of PM-fiber from which the PM-coupler is constructed and the function of the coupler in the laser cavity.

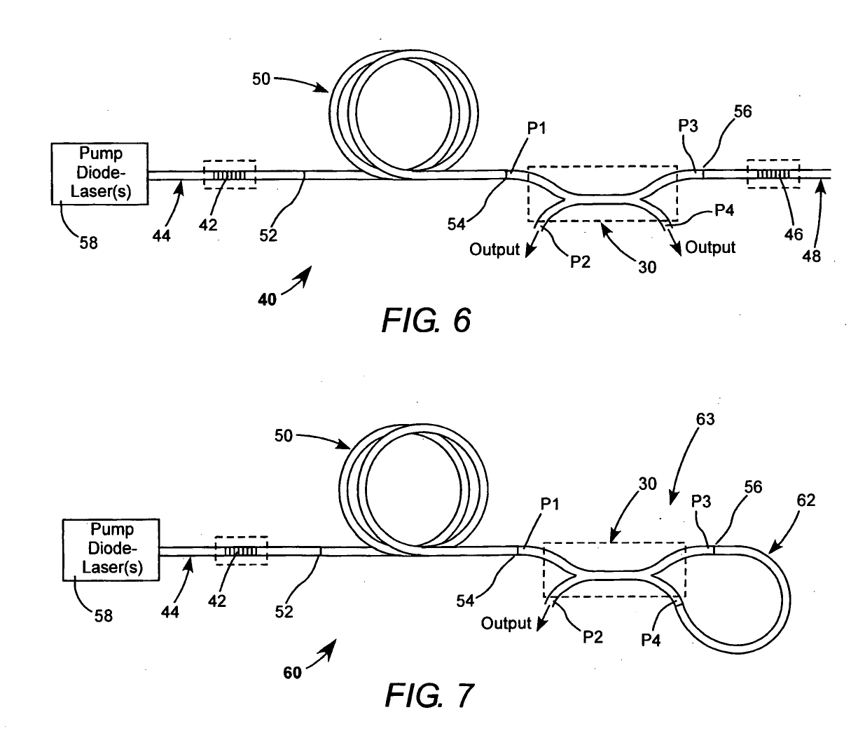

FIG. 6 schematically illustrates one preferred embodiment 40 of a CW fiber-laser in accordance with the present invention. Laser 40 has a standing-wave “all-fiber” fiber-laser cavity defined by a fiber Bragg grating (hereinafter FBG) 42, here, written into a length of optical fiber 44, and by another FBG 46, here, written into a length of optical fiber 48. The laser cavity includes a length of gain-fiber 50 and a four-port PM-coupler 30 having ports 1-4 designated as ports P1, P2, P3, and P4 respectively. Preferably gain-fiber 50 and optical fibers 44 and 48 in which FBGs 42 and 46, respectively, are written are each PM-fibers.

A gain-fiber S0 as referred to herein is an optical fiber having a rare-earth-doped core. Although Erbium ions are most commonly used as a rare-earth element in gain optical fibers, ions of different rare earth elements such as Neodymium (Nd), Ytterbium (Yb), Praseodimium (Pr), Holmium (Ho), Samarium (Sm), Thulium (Tm), and Europium (Eu3+) may also be used. A beam having a wavelength within the gain spectrum of the rare-earth dopant and propagating in the core of the gain-fiber experiences gain if a population inversion has been established by absorption of optical pump radiation (pump light) by the rare-earth ions. A gain-fiber can be a single-clad or double-clad fiber, and can be a single-mode fiber or a few mode, for example, less than 5 modes, fiber.

In laser 40, FBGs 42 and 46 are each maximally reflective for the laser radiation. FBG 42 is transparent to the wavelength of optical pump-radiation. The optical pump radiation (pump light) is supplied from a source 58 thereof, preferably including one or a plurality of diode-lasers. Source 58 is coupled to optical fiber 44 and delivers pump radiation to gain fiber 50 through fiber Bragg grating 42. Here, gain-fiber 50 can be a single clad fiber with pump light being delivered into the core of the fiber.

PM-coupler 30, here, is incorporated into the fiber laser cavity by splicing ports P1 and P3 thereof to gain fiber 50 and optical fiber 48 respectively. A fraction of radiation circulating (oscillating in the cavity) is coupled out of the cavity (as output radiation) via port P4 of the PM-coupler in one direction of circulation and via port P2 of the circulator in the opposite direction of circulation. It is contemplated that in this embodiment of the inventive laser the fraction (α) of radiation being coupled out in each direction would be between about (1%) and (99%).

It should be noted, here that the particular splicing together of components represented by spliced joint 52 between optical fiber 44 (including Bragg grating 42) gain-fiber 50, spliced joint 54 between PM-coupler 30 and the gain-fiber, and spliced joint 56 between the PM-coupler and optical fiber 48 (including Bragg grating 46) should not be considered limiting. From the functional point of view, the fiber-laser cavity between fiber Bragg gratings 42 and 44 can be considered as being essentially one continuous length of optical fiber.

Because of the all-fiber cavity construction, and with careful matching of core dimensions or mode-field at any spliced joints in the cavity, the PM-coupler introduces less intracavity loss, for example, less than about 0.3 dB, than above-discussed prior-art polarizer devices that have been used in a fiber-laser cavity. This provides a more efficient polarized fiber-laser than is possible with those prior-art polarizers. A PM-coupler can be made compatible with other intra-cavity elements, such as a FBG written in a similar PM-fiber, a passive PM-fiber, and polarization maintaining gain-fiber. Providing a similar mode-field diameter for all elements reduces splicing loss and risk of optical and thermal damage at splicing points. This can provide improved reliability of the inventive fiber-laser over that of prior-art polarized fiber-lasers.

FIG. 7 schematically illustrates another preferred embodiment 60 of a CW polarized fiber-laser in accordance with the present invention similar to fiber-laser 40 of FIG. 6, but wherein the standing-wave fiber-laser cavity is terminated by FBG 42 and a Sagnac interferometer formed by splicing a loop of optical fiber 62 between ports P3 and P4 of PM-coupler 30. Sagnac interferometer 63 can be considered as including the fiber-loop and the PM-coupler, with PM-coupler being in the laser cavity. Because of this, the Sagnac interferometer functions as an output coupling mirror and as an intracavity polarizer, selecting a polarization mode with the lowest intracavity loss.

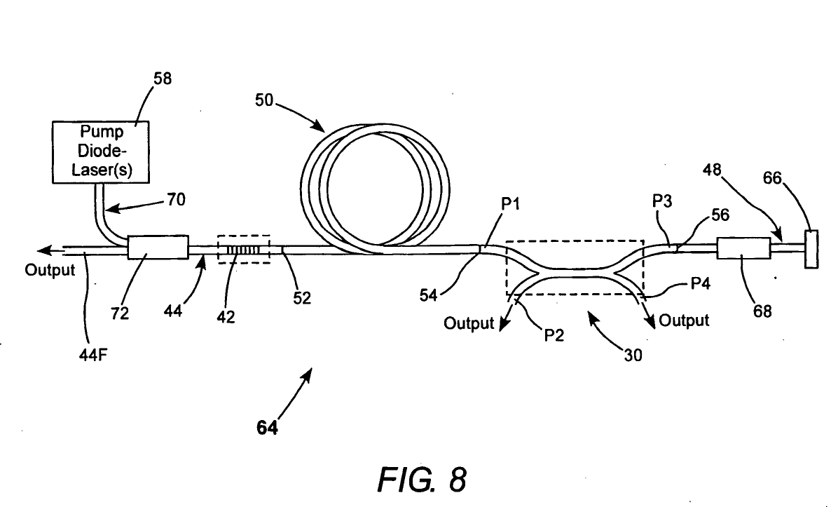

FIG. 8 schematically illustrates one preferred embodiment 64 of a pulsed fiber-laser in accordance with the present invention. Laser 40 has a standing-wave fiber-laser cavity defined (terminated) by a FBG 42 written into a length of optical fiber 44, and by a multilayer dielectric mirror 66. Dielectric mirror 66 is depicted here as a separate optical element, butt coupled to an end of optical fiber 48, but could also be deposited onto that end of the optical fiber. The laser cavity includes a length of gain-fiber 50 and a four-port PM-coupler 30 as described above in other embodiments of the inventive laser. The PM-coupler functions as an output coupling element and a polarizing element as discussed above with reference to laser 40.

A modulating element 68 is included in optical fiber 48 is located in the fiber laser resonator to provide pulsed operation thereof. Modulating element 68 may be a an acousto-optical modulator (AOM), or an electro-optical modulator (EOM), or a saturable absorber. Such elements can provide mode-locked, or Q-switched pulsed operation. After passing many (depending on the Q-factor of the fiber-laser cavity) times through PM-coupler 30, linearly polarized optical pulses will be formed inside the cavity due to polarizing properties of the PM-coupler.

In laser 64, optical pump radiation is supplied from a source 58 thereof via an optical fiber 70 and a WDM coupler 72. Pump radiation in this case is directed into the core of optical fiber 44, and then into the core of the gain-fiber. It is also possible to replace WDM coupler 72 with a fiber coupler for directing the pump radiation into cladding of optical fiber 44 and then into cladding of the gain-fiber. Optical fiber 44 and gain-fiber 50 in this case would preferably a double-clad fiber an inner cladding in which the fiber core is surrounded an inner cladding, the inner cladding being surrounded by an outer cladding by an outer cladding. The pump radiation would be directed into the inner cladding. As couplers for coupling radiation into inner cladding of double clad optical fibers are well-known to practitioners of the art to which the present invention pertains, no further description of such couplers is provided herein. One such combiner is described in U.S. Pat. No. 5,864,644 to Di Giovanni et al.

Those skilled in the art will recognize without further description or illustration that above-described lasers 40 and 60 may also be constructed using double clad optical fibers, and optically pumped via a cladding coupler. Directing pump light into the inventive lasers via a WDM coupler or via a cladding coupler also provides an option that FBG 42 can be partially transparent to the laser radiation allowing output radiation to be delivered from free end 44F of optical fiber 44.

In this case coupler 30 would preferably be configured as a PM-tap with less than about 1% of circulating radiation in the cavity being coupled out by the coupler. This would mean that the PM-coupler was function primarily as a polarizing element in the cavity with outcoupling being only just sufficient to establish selective loss between polarization modes. FBG 42 may have a transmission of about 5% for laser radiation such that the primary output of the laser is from optical fiber 44.

It should be noted that pulsed-mode operation of the inventive fiber-lasers without a modulation element in the cavity can be achieved by pump modulation, i.e., by modulating the output of pump light source 58. Modulating laser output by pump modulation is often referred to as gain-switching by practitioners of the art. When pump light source 58 is a diode-laser or an array thereof, modulation of the source, and accordingly the laser output, can be at any frequency up to about 10 MHz. It should be noted however that pump-modulation will not provide Q-switched operation or mode-locked operation.

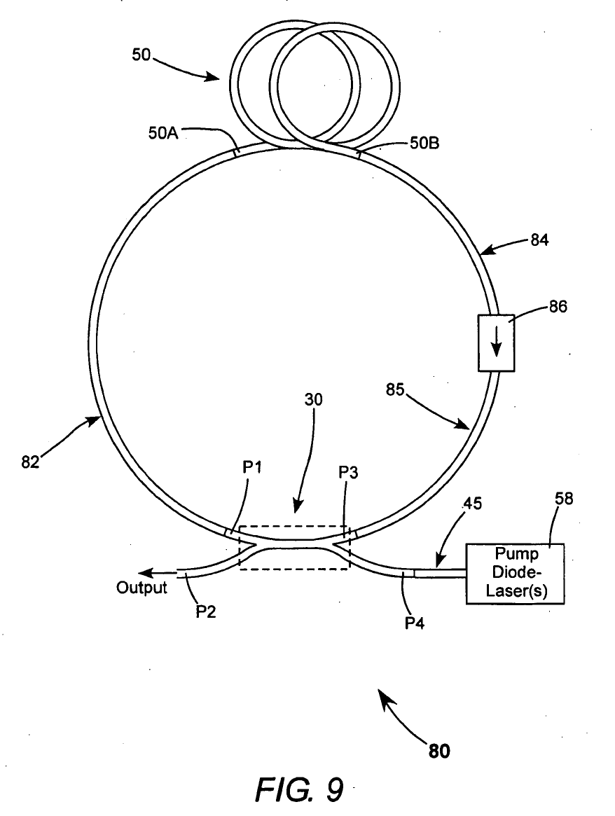

Above-described embodiments of the inventive polarized fiber-laser include the optical fiber equivalent of a standing-wave cavity or resonator, wherein light circulates in forward and reverse directions in the resonator. The inventive lasers may also be configured with the fiber-laser equivalent of a traveling wave (ring) resonator. A description of one such embodiment of the inventive laser is set forth below with reference to FIG. 9.

Here, a polarized fiber-laser 80 including a CW traveling-wave ring-resonator is formed by splicing an optical fiber 82 between free end 50A of a gain-fiber 50 to port P1 of a four-port PM-coupler 30, splicing an optical fiber 84 to an optical fiber isolator 86, and by splicing an optical fiber 85 between optical isolator 86 and port P3 of the PM-coupler. Isolator 86 is preferably a polarization maintaining isolator. Isolator 86 causes laser radiation generated by the gain fiber to travel in one direction only in the ring resonator. A pump light source 58 is connected to port P4 of PM-coupler 30 via an optical fiber 45. PM-coupler 30, here, is configured as a PM-WDM and couples pump light from source 58 into the core of the ring-resonator. Output radiation is delivered via port P2 of PM-coupler (PM-WDM) 30. In laser 80, PM-coupler 30 has a triple function, functioning as a polarizing element, a WDM-coupler and an output coupler.

In general, an intra-cavity PM-WDM can be used in lasers in accordance with the present invention to combine light at two different wavelengths in one fiber or split light from one fiber into two different fibers. The PM-WDM can also be used to couple pump light into a gain fiber as described above, to take light out of a laser cavity, or to attenuate amplified spontaneous emission (ASE) at the wavelength other than the laser wavelength by tapping the ASE wavelengths preferentially from the laser cavity. All of these functions of course are fulfilled while providing the function of an intra-cavity polarizing element with minimized loss for the preferred polarization of the laser output.

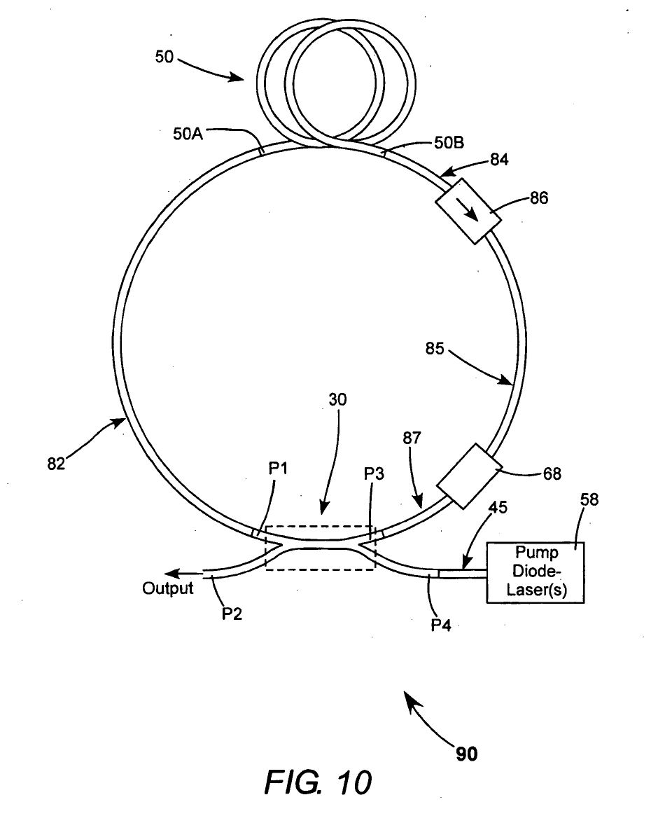

FIG. 10 schematically illustrates one embodiment 90 of a pulsed, polarized fiber laser in accordance with the present invention including traveling-wave ring-resonator. Laser 90 is similar to laser 80 with an exception that a modulating device 68 is included in the ring resonator for providing pulses mode operation thereof. The modulator is included by connecting isolator 86 to one end of the modulator via optical fiber 85, and by splicing an optical fiber 87 between the other end of the modulator and port P3 of the PM-coupler. PM-coupler 30 has the same, triple, function as in laser 80 of FIG. 9.

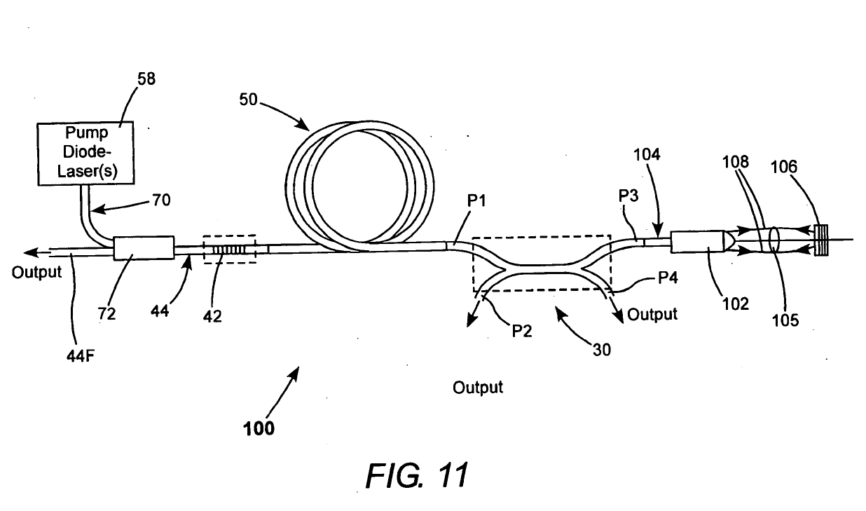

An experimental example of a mode-locked, ultrafast, pulsed polarized fiber-laser in accordance with the present invention has been fabricated for evaluation. A description of the laser and experimental results is set forth below beginning with reference to FIG. 11. Here, a polarized fiber-laser 100 is configured generally in accordance with laser 64 of FIG. 8, but with modulator 68 omitted and replaced in laser 100 by a polarization-maintaining collimator (PM-collimator) 102 connected by an optical fiber 104 to port P3 of PM-coupler 30. Multilayer dielectric mirror 66 of laser 64 is omitted and replaced in laser by a semiconductor saturable absorber mirror (SESAM or simply SAM) 106. SESAM 106 and fiber Bragg grating 42 form the resonant cavity of laser 100. SESAM 106 is spaced apart from polarization maintaining collimator 102, i.e., from the optical fiber portion of the laser cavity, and a beam 108 circulating in the laser cavity is focused onto to the SESAM by an aspheric lens 105 located between the collimator and the SESAM.

FBG 42 has a center wavelength of λ_{c}=1064.3 nanometers (nm) and acts as a terminating mirror for the laser cavity, as discussed above, and also acts as a spectrally selective element in the cavity. Pump light (pump radiation) source 58 is a fiber-pigtailed, single-mode diode-laser operating at λₚᵤₘₚ=980 nm with a maximum power output of between about 200 mW and 300 mW. The pump light source is spliced to the end of the cavity and propagates through FBG 42 to achieve a population inversion in the Yb-doped fiber. This technique of pumping through the FBG reduces polarization crosstalk, the length of the laser cavity, and intracavity loss (by removing the WDM from the laser cavity).

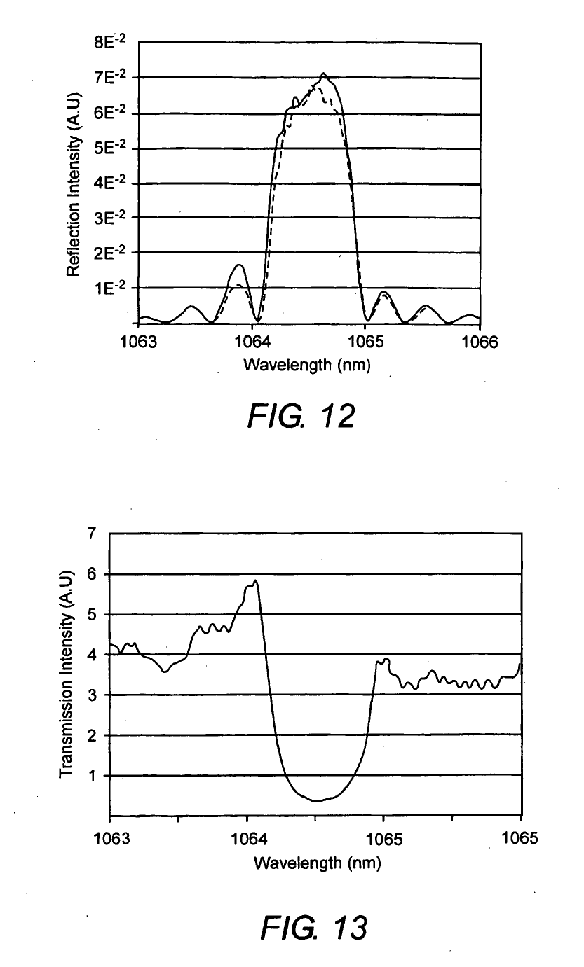

The FBG was written in PM fiber by Bragg Photonics Inc. of Quebec City, Canada. The FBG has a center wavelength λ_{c}, bandwidth Δλ and reflectivity R of 1064 nm, 0.80 nm and 95%, respectively. FIG. 12 is a graph schematically illustrating measured reflected intensity as a function of wavelength for FBG 42 with the grating oriented in both forward (dashed curve) and reverse (solid curve) directions with respect to the pump light direction and with the white light source of the measuring apparatus divided out. FIG. 13 is a graph schematically illustrating measured reflected intensity as a function of wavelength for FBG 42 in the reverse direction, again with the white light source of the measuring apparatus divided out. The FBG 42, in this example of laser 100, was ordered from the manufacturer as unchirped, but some chirp (a small lack of dispersion symmetry) was evident from a difference in the output pulse shape and spectrum depending on which direction was selected for the FBG when used in the cavity. This should not be construed as a criticism of that particular manufacturers product but as a caution that such difference can occur due to normal manufacturing tolerances. In the example best results were obtained with the FBG in the reverse direction as discussed further hereinbelow.

PM coupler 30, in this example, is a PM-coupler manufactured by SIFAM Fiber Optics Ltd of Torquay, UK. The PM-coupler couples out of the cavity 1% of light in each port P2, and P4. Insertion loss for the slow-axis is 0.2 dB while for the fast-axis it is about 1 dB.

Gain fiber 50 in this example was an Yb-doped PM-fiber, part number FUD-3237, description: PM-YSF-5/125, obtained from Nufern Corporation of East Granby, Conn. The gain fiber has a length of about one meter (1.0 m) and has low doping concentration aimed at reducing photo-darkening. Other parameters of the gain fiber are a mode-field diameter (MFD) of 6.8±1.0 micrometers (μm) at a wavelength of 1064 nm; a core NA of 0.12±0.02; a peak core absorption at 915 nm of 30±10 decibels per meter (dB/m); a core diameter of 5.5 μm; a cladding diameter of 125.0 μm; and a birefringence of ≧2.0×10⁻⁴.

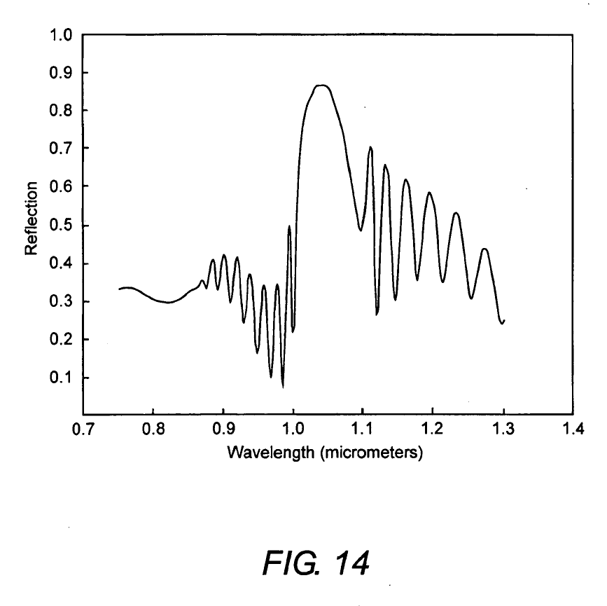

SESAM 106 was obtained from the Swiss Federal Institute of Technology (ETH) of Zurich, Switzerland. It is one of several such SESAMS investigated for use in the exemplary laser 100, and that which provided the best result, in this case. This should not be taken as an endorsement of that manufacturer's products, but as a caution that SESAMs are complex, difficult-to-manufacture, semiconductor devices, and that it may be found prudent when building a laser such as laser 100 to experiment with several devices to find which thereof works optimally with other components of the laser. FIG. 14 is a graph schematically illustrating reflectivity as a function of wavelength for the SESAM 106 that provided the optical results in the exemplary laser.

Manufacturer's data for the SESAM are summarized as follows. At a wavelength of 1052 nm: saturation fluence is 34 microjoules per square centimeter (μJ/cm²); modulation depth (ΔR %) is 14.8; non-saturable losses (Rₙₛ %) are 1.4; low intensity reflection (Rₗᵢₙ %) is 83.8; high intensity reflection (Rₙₗᵢₙ %) is 98.6; and 1/e decay (picoseconds—ps) is 42.9. At a wavelength of 1064 nm: saturation fluence is 27 μJ/cm²; modulation depth is 20.3%; non-saturable losses are 1.5%; low intensity reflection is 78.2%; high intensity reflection is 98.5%; and 1/e decay is 78 picoseconds (ps).

Light 108 is coupled from to and from the SESAM to the optical fiber portion of the laser cavity via the combination of PM-collimator 102 and aspheric lens 105. PM collimator 102 casts a beam with diameter of 4.0 millimeters (mm) on aspheric lens 105, which has a focal length of 3.1 mm. This combination results in a diffraction-limited beam waist diameter of 1.05 μm on the SESAM, resulting in a spot-area Aₛₚₒₜ on the SESAM of between about 1.0 and 1.5 square micrometers (μm²). This spot-area, coupled with intracavity power, yields ample power density on the SESAM suitable for stable operation in the mode-locked regime.

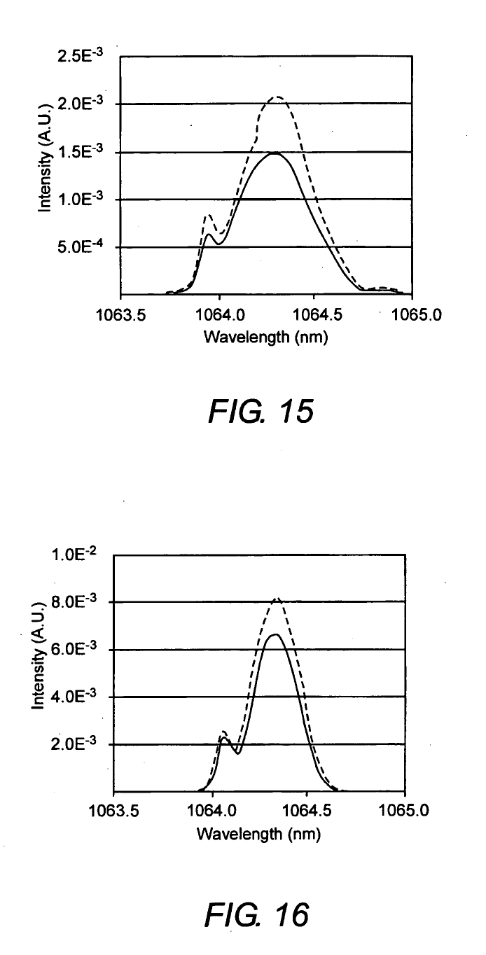

In mode-locked operation the laser emits a very stable pulse train. The fundamental repetition rate is 45 megahertz (MHz). FIG. 15 schematically illustrates the measured spectrum of sample pulses having an average power of 1.4 mW and 1.0 mW (indicated by dashed and solid curves respectively). These pulses were output through FBG 42 via free end 44F of optical fiber 44. The. FBG was in reverse orientation. The 1.4 mW pulses have a duration of 4.5 ps, and the 1.0 mW pulses have a duration of 5.4 ps.

FIG. 16 schematically illustrates the measured spectrum of sample pulses having an average power of 1.4 mW and 1.0 mW, again indicated by dashed and solid curves respectively. These pulses were also output through FBG 42 via free end 44F of optical fiber 44, but with FBG 42 in forward orientation. The 1.4 mW pulses have a duration of 7.2 ps, and the 1.0 mW pulses have a duration of 6.3 ps.

It is emphasized that experimental data presented above are merely exemplary and represent the best results that were obtained with the experimental laser. There was some variation in pulse characteristics in various experimental variations in the laser. These variations were most evident for different SESAMs. Such variations were observed even between SESAMs grown in the same semiconductor chip. Further, pulse duration was observed to change significantly with small adjustments of coupling mounts and focusing location on the SESAM. By way of example, observations of pulses having a duration of greater than 10.0 ps were made even at identical power settings that had produced pulses of shorter duration.

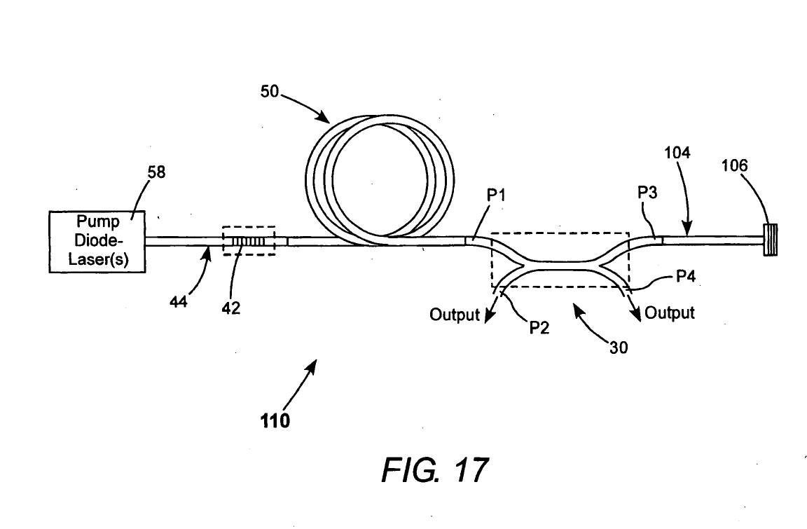

Continuing now with a reference to FIG. 17, another possible embodiment 110 of a mode-locked, pulsed, polarized fiber-laser in accordance with the present invention is described. Laser 110 is similar to above-described laser 100 of FIG. 11 with exceptions as follows. Collimator 102 and aspheric focusing lens 105 of laser 100 are omitted, and SESAM 106 is butt coupled directly to optical fiber 104, which is spliced port P3 of coupler 30. Also, WDM 72 of laser 100 is omitted, and in laser 110, pump light from source 58 thereof is coupled directly into end 44F of optical fiber 44 and enters the laser cavity through FBG 42. This means that output must be taken from one of ports P2 and P4 of PM-coupler 30.

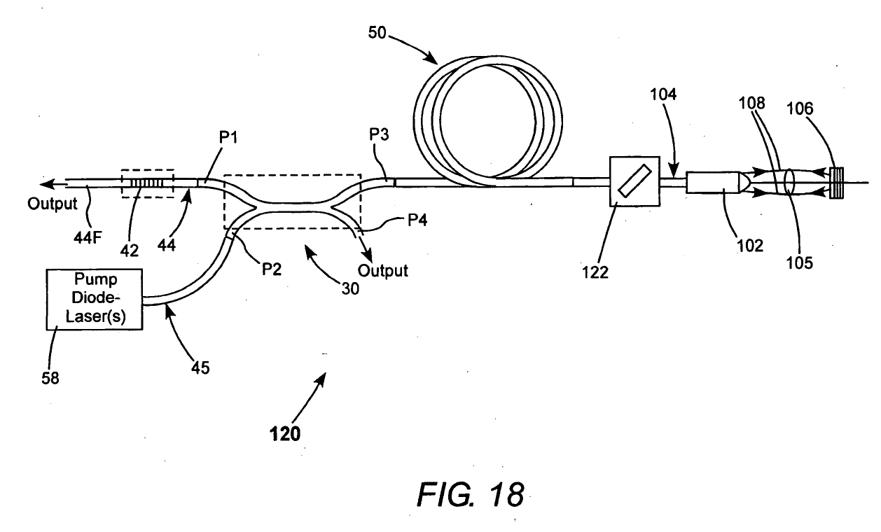

FIG. 18 schematically illustrates yet another preferred embodiment 120 of a mode-locked, standing-wave-cavity, pulsed fiber-laser in accordance with the present invention. Laser 120 is similar to laser 100 of FIG. 11 with an exception that pump light is coupled directly into the laser cavity without passing through FBG 42. In laser 120, PM-coupler 30 is located in the fiber laser cavity between FBG 42 and gain fiber 50. Here, the PM-coupler is configured as a PM-WDM, and pump light from source 58 is delivered via optical fiber 45 to port P2 of the PM-WDM to be coupled into the cavity. As coupler 30, here is configured to optimally couple the pump light wavelength into the cavity, less than about 1.0% of the laser radiation is coupled out of the laser cavity via port P4 of the PM-WDM. Laser output is preferably delivered through fiber Bragg grating 42 and out of free end 44F of optical fiber 44 as described above with reference to laser 100. In laser 120, the intracavity PM-coupler 30 functions as a WDM, an output coupler, and a polarizing element in a manner similar to that described above with reference to the PM-coupler in laser of 80 of FIG. 9. In laser 120 an additional polarizing element 122 such as a bulk polarizer or a fiber polarizer optionally located in the laser cavity, here to significantly increase the polarization ratio above 20 dB. Those skilled in the art will recognize from the description provided above, without further illustration, that laser 120 could be reconfigured by omitting collimator 102 and aspheric lens 105 and butt coupling SESAM 106 to the laser cavity (optical fiber 104 thereof), as illustrated in FIG. 17.

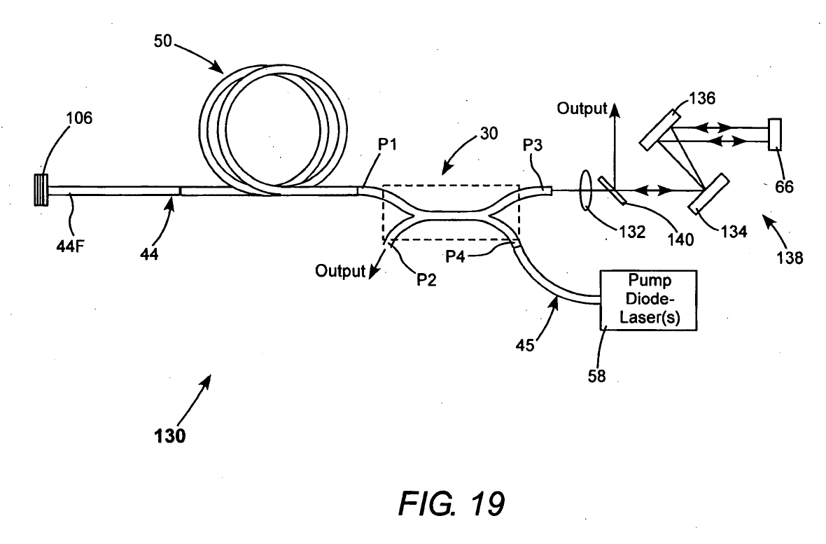

FIG. 19 schematically illustrates still another preferred embodiment 130 of a mode-locked, standing-wave-cavity, polarized, pulsed fiber-laser in accordance with the present invention. Laser 120 includes a laser cavity formed between a highly reflective dielectric mirror 66 and a SESAM 106. The laser cavity includes a gain-fiber 50, preferably a PM gain-fiber, as in other lasers described above. SESAM 106 is butt coupled to end 44F of an optical fiber 104 which is spliced to one end of the gain-fiber. The opposite end of the gain-fiber is spliced to port P1 of a PM-coupler here configured as a PM-WDM for coupling pump light into the laser cavity. A pump light source 58 is coupled to port P4 of PM-coupler via an optical fiber 45.

Mirror 66 is spaced apart in free space from port P3 of PM-coupler 30. Laser radiation circulating in the laser cavity exits and enters the optical fiber portion of the cavity via this port of the PM-coupler. Radiation leaving port P3 is collimated by a collimating lens 132 is diffracted by diffraction gratings 134 and 136 and is incident on mirror 66. Mirror 66 reflects the radiation back along the incidence path and the radiation is focused by collimating lens 132 back into port P3 of the PM-coupler. A portion of the radiation propagating in the free space between the PM-coupler and mirror 66 is directed out of the laser cavity, as output radiation, by a beam-splitting mirror (beam-splitter) 140.

Diffraction gratings 134 and 136 are configured, as is known in the art, as a device 138 for providing group dispersion compensation (negative GDD) for circulating laser radiation. Such a device is also known as a pulse compressor and is usually deployed in lasers having a temporal pulse width of 500 femtoseconds (fs) or less. By way of example, in fiber-lasers operating at wavelengths shorter than 1.3 μm, the negative group dispersion delay introduced by a pulse compressor offsets a positive group dispersion delay (positive GDD) introduced by dispersion in optical fibers of the laser cavity. This positive GDD, if not offset by the negative GDD of diffraction grating pair 138, would cause an increase in the temporal pulse width (pulse duration) of laser output pulses. Those skilled in the art will recognize that any of the above-described embodiments of the inventive mode-locked polarized fiber laser could be reconfigured to include a negative GDD providing device. Such a device could be a grating pair as described in laser 130 or any other negative-GDD providing device known in the art, such as a fiber with anomalous dispersion, a chirped fiber Bragg grating, a chirped bulk grating, a prism, a Gires-Tournois interferometer (GTI), or a multilayer dielectric or semiconductor mirror (NGDD mirror) having properties similar to a GTI.

In summary, the present invention is described above in terms of a preferred and other embodiments. The invention is not limited, however, to the embodiments described and depicted. Rather, the invention is limited only by the claims appended hereto.

1. A fiber-laser, comprising:
a laser cavity including a gain-fiber; and
a polarization maintaining fiber coupler (PM-coupler) located in said laser cavity and configured such that the fiber laser delivers substantially plane-polarized output radiation.

2. The laser of claim 1, wherein said PM-coupler has a different coupling ratio for two different polarization states.

3. The laser of claim 2, wherein coupling ratios are different by greater than about 5%.

4. The laser of claim 1, wherein said PM-coupler has a different insertion loss for two different polarization states.

5. The laser of claim 4, wherein insertion losses are different by between about 1% and 5%.

6. The laser of claim 4, wherein insertion losses are different by greater than about 5%.

7. The laser of claim 1, wherein said plane-polarized output radiation has an extinction ratio greater than about 13 dB.

8. The laser of claim 7, wherein said plane-polarized output radiation has an extinction ratio greater than about 20 dB.

9. The fiber-laser of claim 1, further including a modulator located in said laser cavity for causing said fiber-laser to operate in a pulsed mode.

10. The laser of claim 9, wherein said modulator is a saturable absorbing device and causes said fiber-laser to operate in a mode-locked pulsed mode.

11. The laser of claim 10, wherein said saturable absorbing device is a saturable absorbing mirror and provides one terminating mirror of said laser cavity.

12. The laser of claim 1, wherein said laser cavity is terminated by first and second fiber Bragg gratings.

13. The laser of claim 1, wherein said laser cavity is terminated by a mirror and a fiber Bragg grating.

14. The laser of claim 1, wherein said laser cavity, is terminated by a fiber Bragg grating and a Sagnac interferometer including said PM-coupler.

15. The fiber-laser of claim 1, wherein said PM-coupler functions in said laser cavity as a device to couple output radiation out of said laser cavity.

16. The fiber-laser of claim 1, wherein said PM-coupler is configured as a polarization maintaining wavelength division multiplexer and functions in said laser cavity as a device to couple optical pump light into said gain-fiber of said laser cavity.

17. The laser of claim 1, wherein said laser cavity is a linear cavity.

18. The laser of claim 1, wherein said laser cavity is a ring cavity.

19. The laser of claim 1, wherein said gain-fiber is a polarization maintaining gain-fiber.

20. The laser of claim 1, wherein said PM-coupler includes one of a Panda type PM-fiber, a tiger type PM-fiber, a bow-tie type PM-fiber, and an elliptical core type PM-fiber.

21. A fiber-laser, comprising:
a laser cavity terminated by first and second reflective devices and including a gain-fiber; and
a polarization maintaining fiber coupler (PM-coupler) located in said laser cavity and wherein the ratio of coupler losses for two orthogonal polarization states is selected so that upon multiple passes of laser radiation through said coupler, one of the two polarizations states will be substantially suppressed allowing the fiber laser to deliver substantially plane-polarized output radiation.

22. A fiber laser as recited in claim 21, wherein the ratio of losses is selected by controlling the coupling ratio and the actual differential losses of the coupler for the two orthogonal polarization states.

23. The laser of claim 21, wherein said PM-coupler functions additionally as one or more of an output coupling element, a polarization maintaining wavelength division multiplexing (PM-WDM) element for coupling pump light into the laser cavity, and a PM-WDM element for attenuating amplified spontaneous emission (ASE) by preferentially coupling such ASE out of the laser cavity.

24. The laser of claim 21, wherein one of said first and second reflective devices is one of a fiber Bragg grating, a multilayer dielectric mirror, a multilayer semiconductor mirror, a semiconductor saturable absorber mirror, and a fiber Sagnac interferometer.

25. The laser of claim 24, wherein said Sagnac interferometer includes said PM-coupler.

26. The laser of claim 21, wherein said gain-fiber is a polarization maintaining gain-fiber.

27. The laser of claim 21, wherein said PM-coupler includes one of a Panda type PM-fiber, a tiger type PM-fiber, a bow-tie type PM-fiber, and an elliptical core type PM-fiber.

28. The laser of claim 21, wherein said gain-fiber is a double-clad polarization maintaining gain-fiber.

29. A fiber-laser, comprising:
a laser cavity terminated by a fiber Bragg grating and a reflective device and including a gain-fiber;
a source of optical pump light, said optical pump light source and said fiber Bragg grating being arranged such that pump light from said source thereof is delivered to said gain-fiber through said fiber Bragg grating; and
a PM-coupler located in said laser cavity and wherein the ratio of coupler losses for two orthogonal polarization states is selected so that upon multiple passes of laser radiation through said coupler, one of the two polarizations states will be substantially suppressed allowing the fiber laser to deliver substantially plane-polarized output radiation.

30. The fiber-laser of claim 29, wherein said gain-fiber has a core and said pump light is delivered to said core of said gain-fiber.

31. The fiber-laser of claim 29, wherein said gain-fiber has a core surrounded by first cladding, said first cladding being surrounded by a second cladding, and wherein said pump light is delivered to said first cladding of said gain-fiber.

32. A fiber-laser, comprising:
a laser cavity terminated by first and second reflective devices and including a gain-fiber;
a PM-coupler located in said laser cavity and wherein the ratio of coupler losses for two orthogonal polarization states is selected so that upon multiple passes of laser radiation through said coupler, one of the two polarizations states will be substantially suppressed allowing the fiber laser to deliver substantially plane-polarized output radiation; and
wherein one of said first reflective device is a semiconductor saturable absorbing mirror (SESAM) and causes said fiber laser to operate in a mode-locked pulsed mode.

33. The fiber-laser of claim 31, wherein said second reflective device is a fiber Bragg grating, the fiber-laser further includes a source of optical pump light for energizing said gain-fiber and said optical pump light source and said fiber Bragg grating are arranged such that said optical pump light is delivered to said gain-fiber through said fiber Grating.

34. A method of operating a fiber laser, said fiber laser having cavity including a gain fiber and a polarization maintaining fiber coupler comprising the steps of:
optically pumping the fiber laser to generate laser radiation; and
suppressing one of two polarization states circulating in the resonator by creating a difference in coupler loss experienced by one of the two orthogonal polarization states as it interacts with the coupler allowing the fiber laser to deliver plane-polarized output radiation.

35. A method as recited in claim 34, wherein the difference in losses created by the coupler is selected by controlling the coupling ratio and the actual differential losses of the coupler for the two orthogonal polarization states.
